(19) United States
(12) Patent Application Publication
(10) Pub. No.: US 2016/0042756 A1
(43) Pub. Date: Feb. 11, 2016

(54) OPTICAL INFORMATION PLAYBACK DEVICE AND ADJUSTMENT METHOD

(71) Applicant: HITCHI CONSUMER ELECTRONICS CO., LTD., Tokyo (JP)

(72) Inventors: Takeshi OGATA, Tokyo (JP); Makoto HOSAKA, Tokyo (JP)

(73) Assignee: Hitachi Consumer Electronics Co., Ltd., Yokohama-shi, Kanagawa (JP)

(21) Appl. No.: 14/782,919

(22) PCT Filed: Apr. 8, 2013
(86) PCT No.: PCT/JP2013/060573

§ 371 Date: Oct. 7, 2015

(51) Int. Cl. G11B 7/0065; G11B 7/1362; G11B 7/085; G03H 1/26; G03H 1/22

(52) U.S. Cl. CPC G11B 7/0065; G03H 1/265; G03H 1/2286; G11B 7/0857; G11B 7/1362; G03H 2222/56; G03H 2001/2292

(57) ABSTRACT

The objective of the present invention is, using an optical system which performs adjustment, to allow a reference beam optical system to be adjustable with high accuracy. The present invention is an optical information reproduce device which reproduces back information that has been recorded using angle-multiplexing holography on an optical information recording medium, said optical information reproduce device being provided with: a light source for generating a reference light; a first actuator which varies the angle of the reference light that is incident to the optical information recording medium; phase conjugate generation means configured by combining a condenser lens which generates phase-conjugated beams of light that has been transmitted through the optical information recording medium, and a movable mirror; a second actuator which drives the movable mirror; and a reference light measurement unit which measures divergence and convergence of the reference light from the phase conjugate generation means.

### TECHNICAL FIELD

The present invention relates to a device and method for reproducing information from a recording medium using holography.

### BACKGROUND ART

Presently, the Blu-ray Disc™ standard using blue-violet semiconductor laser enables commercialization of optical disks having storage of about 50 GB even for consumer use. It is desired that optical disks will have greater capacity in future to the same level as hard disk drives (HDDs) such as 100 GB to 1 TB.

However, in order to implement such very high density on an optical disk, a technique to increase density by a new method is required apart from a technique to increase density by shortening a wavelength and increasing a numerical aperture of an object lens.

Amid on-going researches on a next-generation storage technique, a hologram recording technique for recording digital information using holography draws attention.

The hologram recording technique is a technique to record information on a recording medium by superimposing signal light including information of page data two-dimensionally modulated by a spatial light modulator on reference light inside the recording medium and causing refractive index modulation in the recording medium by an interference fringe pattern generated then.

To reproduce the information, irradiating the recording medium with the reference light used for recording causes the hologram recorded on the recording medium to act as a diffraction grating, thereby generating diffracted light. This diffraction light is reproduced as the same light as signal light including phase information having been recorded.

The signal light reproduced is two-dimensionally detected at a high speed using a photodetector such as a CMOS and CCD. In this manner, the hologram recording technique realizes recording two-dimensional information on an optical recording medium at a time by one hologram and further reproducing the information. Furthermore, a plurality of page data can be overlaid in a place in the recording medium, thereby achieving high-capacity and high-speed information recording and reproducing.

Patent literature 1 describes “To simplify an optical system in an entire hologram recording reproduce apparatus of a multi-angle system by employing a method of varying an incident angle of reference light to a hologram recording material by varying angles of the reference light.” According to this, “Hologram recording material 50 is irradiated with reference light 200 through a reference light optical system 40 upon reproduce. Here, a traveling direction of transmitted light transmitted by hologram recording material 50 is changed to the opposite direction by a phase conjugate reference light optical system including lens 24 and reflection mirror 25, thereby generating phase conjugate reproduce light. Hologram recording material 50 is irradiated with this phase conjugate reproduce light to generate conjugate reproduce signal light. This reproduce signal light which is introduced to image sensor 26 through signal light optical system 22 and PBS 21, thereby reproducing data. The phase conjugate reference light optical system with a simple configuration can generate phase conjugate reproduce light, allowing for downsizing the optical system.”

### CITATION LIST

### Patent Literature

### PATENT LITERATURE 1: JP-A-2006-317886

### SUMMARY OF INVENTION

### Technical Problem

Meanwhile, there is a problem that a reflecting mirror in a reference light optical system is required to be positioned with high accuracy.

An object of the present invention is to realize adjusting a reference light optical system with high accuracy using an optical system performing adjustment.

### Solution to Problem

The aforementioned problem can be solved by, for example, combining a condenser lens and a movable mirror in a phase conjugate system for generating phase conjugate light.

### Advantageous Effect of Invention

According to the present invention, a reference light optical system can be adjusted with high accuracy.

### BRIEF DESCRIPTION OF DRAWINGS

FIG. 1 is a schematic diagram illustrating an embodiment of a pickup in an optical information reproduce device.

FIG. 2 is a schematic diagram illustrating an embodiment of the optical information reproduce device.

FIG. 3 is a schematic diagram illustrating an embodiment of a pickup in the optical information reproduce device.

FIG. 4a is a schematic diagram illustrating an embodiment of an operation flow of the optical information reproduce device.

FIG. 4b is a schematic diagram illustrating an embodiment of an operation flow of the optical information reproduce device.

FIG. 5 is a schematic diagram illustrating an embodiment of a signal processing circuit in the optical information reproduce device.

FIG. 6 is a schematic diagram illustrating an embodiment of an operation flow of the signal processing circuit.

FIG. 7a is a schematic diagram illustrating an optical path of reproduce reference light with a movable mirror.

FIG. 7b is a schematic diagram illustrating an optical path of reproduce reference light with the movable mirror.

FIG. 7c is a schematic diagram illustrating an optical path of reproduce reference light with the movable mirror.

FIG. 8a is a schematic diagram illustrating an optical path of reproduce reference light with the movable mirror.

FIG. 8b is a schematic diagram illustrating an optical path of reproduce reference light with the movable mirror.

FIG. 8c is a schematic diagram illustrating an optical path of reproduce reference light with the movable mirror.

FIG. 9a is a schematic diagram illustrating an optical path of reproduce reference light with the movable mirror.

FIG. 9b is a schematic diagram illustrating an optical path of reproduce reference light with the movable mirror.

FIG. 9c is a schematic diagram illustrating an optical path of reproduce reference light with the movable mirror.

FIG. 10a is a schematic diagram illustrating an optical path of reproduce reference light with the movable mirror.

FIG. 10b is a schematic diagram illustrating an optical path of reproduce reference light with the movable mirror.

FIG. 10c is a schematic diagram illustrating an optical path of reproduce reference light with the movable mirror.

FIG. 11a is a schematic diagram illustrating an output from a reference light adjustment signal detecting circuit upon scanning with reference light.

FIG. 11b is a schematic diagram illustrating an output from the reference light adjustment signal detecting circuit upon scanning with reference light.

FIG. 12 is a table illustrating changes in reproduce reference light by scanning with reference light corresponding to deviation direction of the movable mirror.

FIG. 13 is a diagram illustrating a flow of adjusting positioning of the movable mirror.

### DESCRIPTION OF EMBODIMENT

Embodiments of the present invention will be described below with drawings.

### Embodiment 1

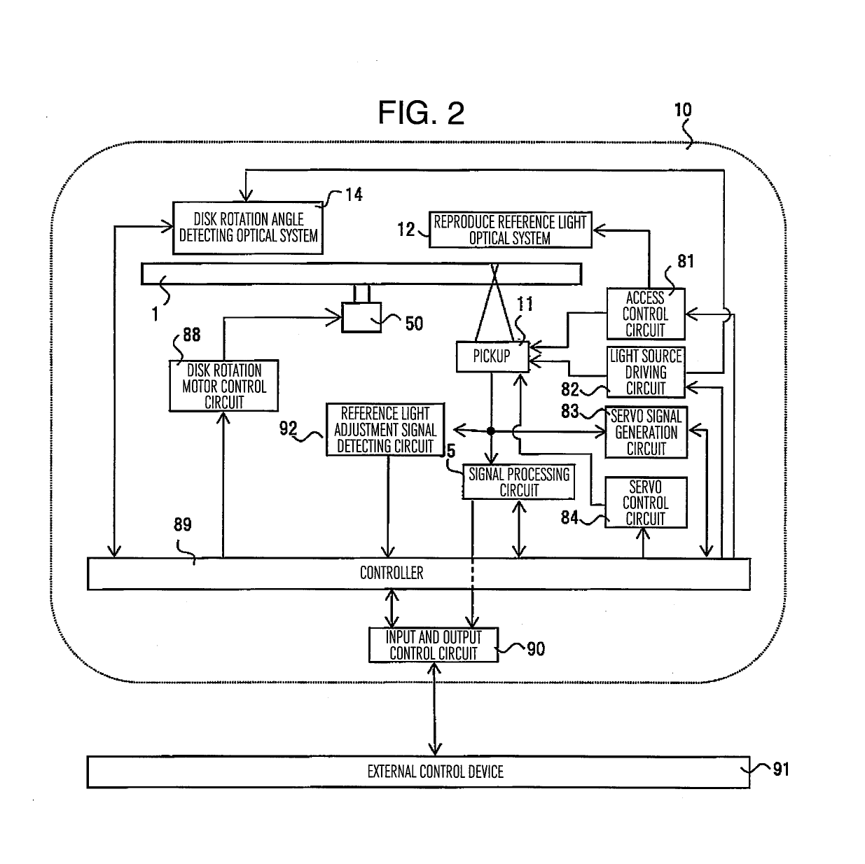

An embodiment of the present invention will be described according to the accompanying drawings. FIG. 2 is a block diagram illustrating a reproduce device of an optical information recording medium for reproducing digital information using holography.

Optical information reproduce device 10 is connected to external control device 91 via input and output control circuit 90. To reproduce information recorded on an optical information recording medium 1, optical information reproduce device 10 sends reproduced information signals to external control device 91 by input and output control circuit 90.

Optical information reproduce device 10 includes pickup 11, reproduce reference light optical system 12, curing optical system 13, disk rotation angle detecting optical system 14 and rotary motor 50. Optical information recording medium 1 is rotatable by rotary motor 50.

To reproduce information recorded on optical information recording medium 1, reproduce reference light optical system 12 generates light wave to allow reference light emitted from pickup 11 to enter optical information recording medium 1. A photodetector in pickup 11 detects reproduce light reproduced by the reproduce reference light. The photodetector will be described later. Signal processing circuit 85 then reproduces signals.

Disk rotation angle detecting optical system 14 detects a rotation angle of optical information recording medium 1. To adjust optical information recording medium 1 to a predetermined rotation angle, disk rotation angle detecting optical system 14 detects a signal corresponding to a rotation angle and then controller 89 controls the rotation angle of optical information recording medium 1 via disk rotation motor control circuit 88 using the detected signal.

Light source driving circuit 82 supplies a predetermined light source driving current to light sources in pickup 11 and disk rotation angle detecting optical system 14. The respective light sources can emit a light beam at a predetermined amount of light.

Also, pickup 11 includes a mechanism allowing pickup 11 to slide in a radial direction of optical information recording medium 1 and a position thereof is controlled via an access control circuit 81.

Meanwhile, a recording technique using the multi-angle principal of holography tends to have very small allowable errors for deviation in reference light angle and wave front.

Therefore, it is required that pickup 11 includes a mechanism for detecting an amount of deviation in the reference light angle and that optical information reproduce device 10 includes a servo mechanism where servo signal generation circuit 83 generates a signal for servo control and the amount of deviation is compensated via servo control circuit 84.

Furthermore, pickup 11 includes reference light measuring unit 15, whereby a wave front of the reference light is measured. Reference light adjustment signal detecting circuit 92 performs calculation and detects an amount of deviation in an adjustment value for reproduce reference light optical system 12. Controller 89 adjusts reproduce reference light optical system 12 with an adjustment value corresponding to the amount of deviation in the adjustment value via the access control circuit 81.

Alternatively, pickup 11 and disk rotation angle detecting optical system 14 may be configured as one optical system for simplification.

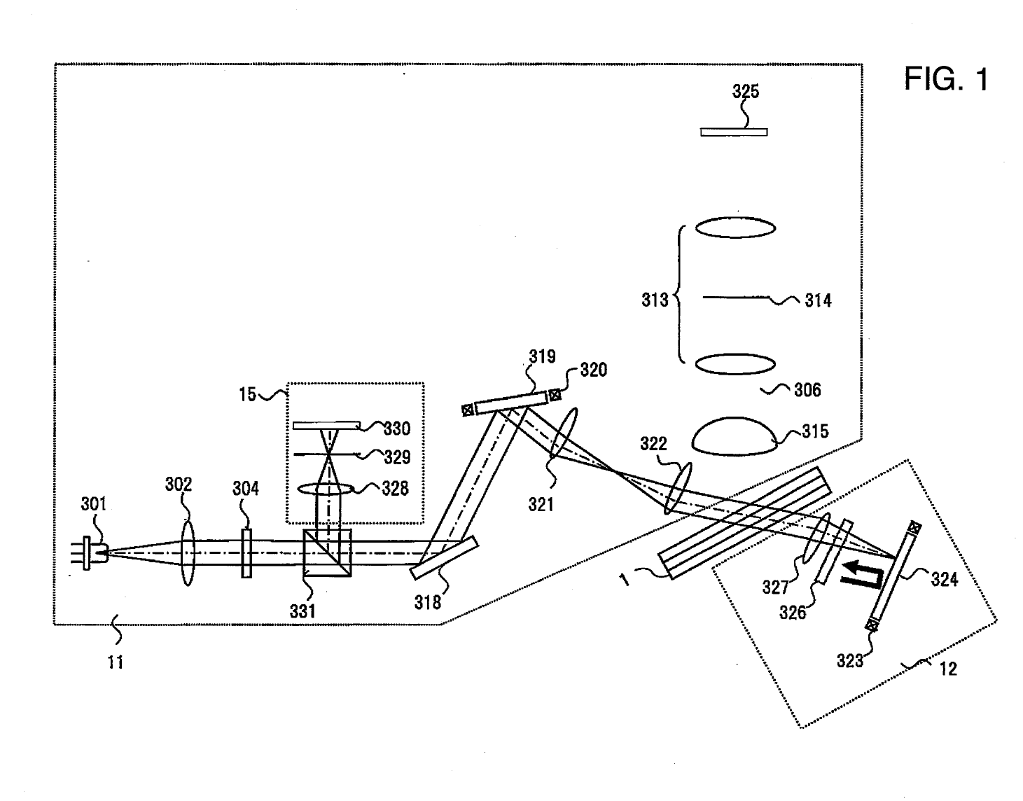

FIG. 1 is a diagram illustrating the principal of reproduce in an exemplary configuration of basic optical system of pickup 11 in optical information reproduce device 10. When information is reproduced, a light beam emitted from light source 301 is transmitted by collimate lens 302, then controlled a polarization direction thereof by optical element 304 including, for example, a ½ wavelength plate such that a ratio of amounts of light of p-polarized light and s-polarized light is a desired ratio and then transmitted through PSB prism 331 for transmitting desired polarized light. The transmitted light is referred to as reference light. The reference light enters galvano mirror 319 via mirror 318. An angle of galvano mirror 319 is adjustable by actuator 320 and thus an incident angle of the reference light entering optical information recording medium 1 after passing lens 321 and lens 322 can be set at a desired angle. Note that, instead of the galvano mirror, an element transforming a wave front of the reference light may be used for setting the incident angle of the reference light. Also, the present embodiment is described as having a configuration where both the Bragg direction and the pitch direction of the reference light are adjustable by galvano mirror 319 for ease of description. Naturally, however, an actuator can be disposed for each adjusting axis for simplification of control. For example, the Bragg direction of the reference light may be adjusted by galvano mirror 319 while the pitch direction of the reference light may be adjusted by a movable prism disposed in upstream of galvano mirror 319. In this case, there is an advantage that the Bragg direction and pitch direction of the reference light can be adjusted individually by a simple configuration.

As described above, the reference light having entered optical information recording medium 1 and transmitted thereby enters reproduce reference light optical system 12.

In reproduce reference light optical system 12, the incident light is transmitted by lens 327 and ¼ wavelength plate 326 and then reflected by movable mirror 324. The reflected light is transmitted through ¼ wavelength plate 326 and lens 327 while passing the same optical path as when entering.

The light having passed through lens 327 is a phase conjugate light beam with the same angle as the reference light but with a different incident direction and, after passing through ¼ wavelength plate 326 twice, polarization thereof is changed. The phase conjugate light beam is referred to as reproduce reference light. The reproduce reference light enters optical information recording medium 1 for the second time.

This reproduce reference light reproduces reproduce light, which propagates through object lens 315, relay lenses 313, and spatial filter 314. Thereafter, the reproduce light enters photodetector 325, allowing recorded signals to be reproduced. As photodetector 325, an image element such as a CMOS image sensor and CCD image sensor may be used. Any element capable of reproducing page data may be used.

Here, in a hologram recorded with varying reference light angles in the same area, a hologram corresponding to each of the reference light angles is referred to as a page and a collection of the pages angle-multiplexed in the same area is referred to as a book.

The reproduce reference light transmitted by optical information recording medium 1 passes lens 322 and lens 321, then is reflected by galvano mirror 319 and mirror 318, and enters PBS 331. The reproduce reference light is reflected by PBS prism 331 and enters reference light measuring unit 15. Reference light measuring unit 15 includes an optical system capable of measuring a magnitude of divergence or convergence of the reproduce reference light and will be described based on, as an example, the knife-edge method used in DVDs or the like in the embodiment.

The light having entered reference light measuring unit 15 passes through lens 328 and spatial filter 329. An intensity distribution of the light is then changed according to a magnitude of divergence or convergence of the reproduce reference light. Photodetector 330 measures this intensity distribution of the light and outputs a signal corresponding to the distributed amount of light.

Here, a configuration of reference light measuring unit 15 may be in any way as long as the configuration realizes measurement of the magnitude of divergence or convergence of the reproduce reference light. Note that reference light measuring unit 15 is disposed in downstream of galvano mirror 319 receiving the reference light reflected by movable mirror 324 in the present embodiment. Disposed in downstream of galvano mirror 319, reference light measuring unit 15 is not required to be movable itself, thus enabling further downsizing and higher speed.

Furthermore, an actuator 323 is attached to movable mirror 324 and an angle and position of the movable mirror is adjusted before reproduce of the information in the manner described later.

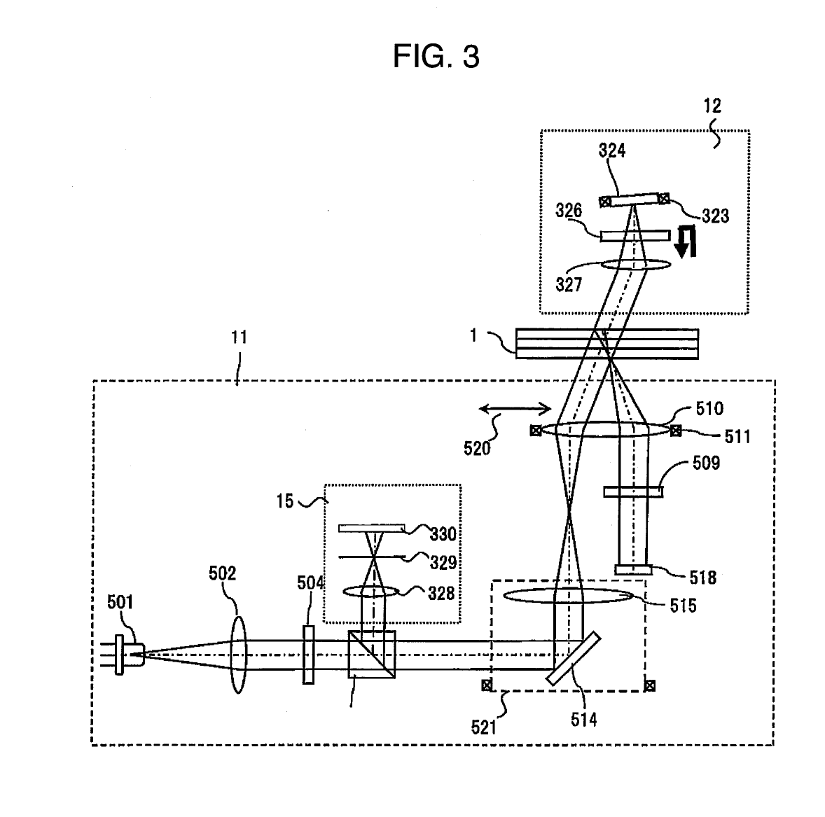

FIG. 3 is a diagram illustrating another configuration of pickup 11. In FIG. 3, when recorded information is reproduced, a light beam emitted from a light source 501 is transmitted through a collimate lens 502, then controlled a polarization direction thereof by an optical element 504 including, for example, a ½ wavelength plate such that a ratio of amounts of light of p-polarized light and s-polarized light is a desired ratio, and then enters PBS prism 505.

The light beam transmitted by PBS prism 505 functions as reference light 512 and enters lens 515 via mirror 514. Lens 515 condenses reference light 512 on a back focus surface of object lens 510. The reference light once condensed on the back focus surface of object lens 510 becomes parallel light for the second time by object lens 510 and enters a hologram recording medium 1.

Here, object lens 510 or optical block 521 can be driven, for example, in a direction denoted with sign 520. Deviation of a position of object lens 510 or optical block 521 along driving direction 520 changes a relative position of object lens 510 and a condensing point on the back focus surface of object lens 510, thereby it becomes possible to set an incident angle of the reference light entering hologram recording medium 1 at a desired angle. Note that, instead of driving object lens 510 or optical block 521, mirror 514 may be driven by an actuator in order to set the incident angle of the reference light at the desired angle.

### <Description on Reproduce System>

As described above, the reference light having entered hologram recording medium 1 and transmitted by hologram recording medium 1 enters reproduce reference light optical system 12.

In reproduce reference light optical system 12, the incident light is transmitted by lens 327 and ¼ wavelength plate 326 and then reflected by movable mirror 324. The reflected light is transmitted by ¼ wavelength plate 326 and lens 327 while passing the same optical path as when entering.

The light having passed through lens 327 is a phase conjugate light beam with the same angle as the reference light but with a different incident direction and, after passing through ¼ wavelength plate 326 twice, polarization thereof is changed. The phase conjugate light beam is referred to as reproduce reference light. The reproduce reference light enters optical information recording medium 1 for the second time.

This reproduce reference light reproduces reproduce light, which propagates through object lens 510 and angle filter 509. Thereafter, the reproduce light enters photodetector 518, allowing a recorded signal to be reproduced.

The reproduce reference light transmitted by optical information recording medium 1 passes lens 510 and lens 515, then is reflected by galvano mirror 514, and enters PBS 505. The reproduce reference light is reflected by PBS prism 505 and enters reference light measuring unit 15. Reference light measuring unit 15 includes an optical system capable of measuring a magnitude of divergence or convergence of the reproduce reference light and will be described based on, as an example, the knife-edge method used in DVDs or the like in the embodiment.

The light having entered reference light measuring unit 15 passes lens 328 and spatial filter 329. An intensity distribution of the light is then changed according to a magnitude of divergence or convergence of the reproduce reference light. Photodetector 330 measures this intensity distribution of the light and outputs a signal corresponding to the distributed amount of light.

Here, a configuration of reference light measuring unit 15 may be in any way as long as the configuration realizes measurement of the magnitude of divergence or convergence of the reproduce reference light.

Furthermore, actuator 323 is attached to movable mirror 324 and an angle and position of the movable mirror is adjusted before reproduce of the information in the manner described later.

The optical system illustrated in FIG. 3 has the configuration where the reproduce light and the reference light enter the same object lens, and thus has an advantage of drastic downsizing over the configuration of the optical system illustrated in FIG. 1.

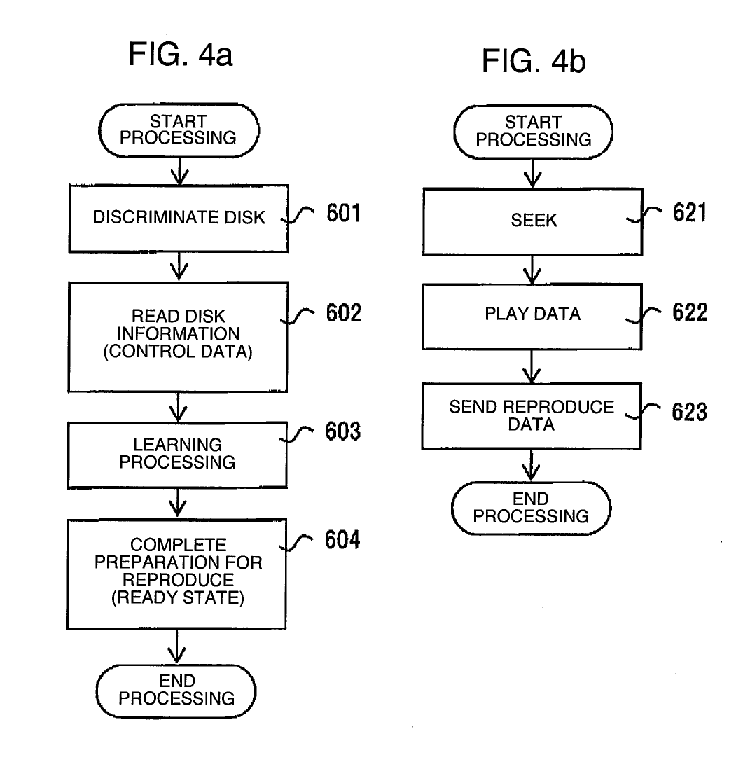

FIG. 4 is a diagram illustrating an operation flow of reproduce in optical information reproduce device 10. Here, especially the flow of reproduce using holography will be described.

FIG. 4(a) is a diagram illustrating an operation flow from insertion of optical information recording medium 1 into optical information reproduce device 10 to completion of reproduce preparation. FIG. 4(b) is a diagram illustrating an operation flow from the completed state of preparation to reproduce of the information recorded on optical information recording medium 1.

As illustrated in FIG. 4(a), when the medium is inserted (601), optical information reproduce device 10 performs disk discrimination as to, for example, whether the inserted medium is a medium for recording or reproducing digital information using holography (602).

As a result of the disk discrimination, when the medium is determined as an optical information recording medium for recording or reproducing digital information using holography, optical information reproduce device 10 reads control data included in the optical information recording medium (603) and acquires information on, for example, the optical information recording medium or various setting conditions for reproduce.

After reading the control data, optical information reproduce device 10 performs various adjustments corresponding to the control data and learning processing related to pickup 11 (604) and completes the preparation for reproduce (605).

In the operation flow from the completed state of preparation to reproduce of the recorded information as illustrated in FIG. 4(b), first in a seek operation (621), the access control circuit 81 is controlled and pickup 11 and reproduce reference light optical system 12 are positioned at a predetermined position in the optical information recording medium. If optical information recording medium 1 includes address information, the address information is reproduced and whether the positioning is performed at the desired position is confirmed. If not disposed at the desired position, an amount of deviation from the predetermined position is calculated and the positioning operation is repeated again.

Thereafter, the reference light is emitted from pickup 11 and the information recorded on the optical information recording medium is read (622). The reproduce data is then sent (613).

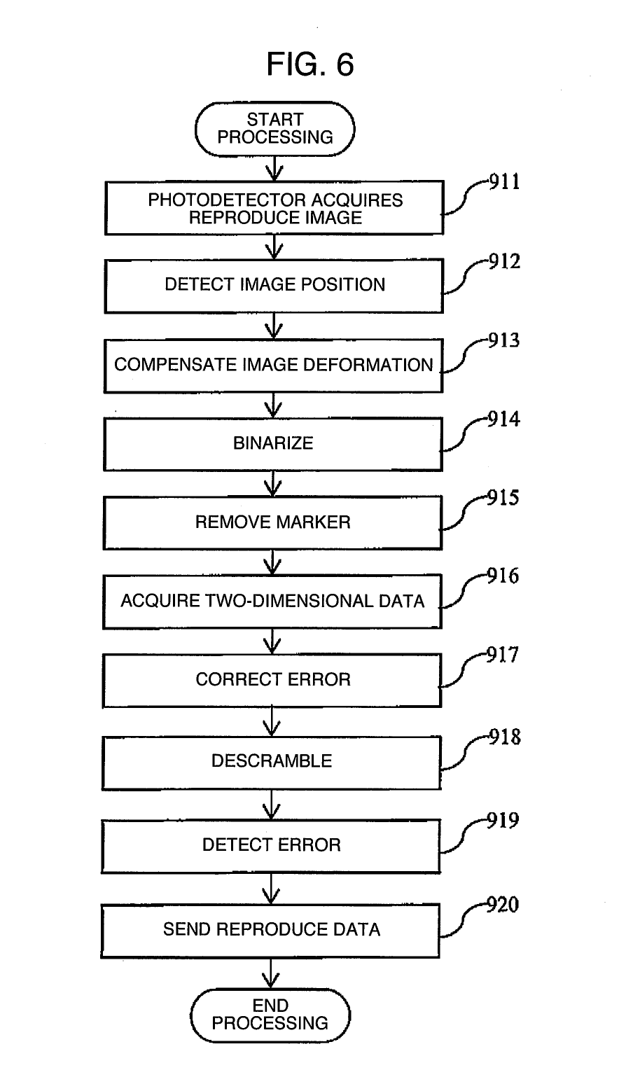

FIG. 6 is a diagram illustrating a processing flow of the reproduce data in signal processing circuit 85 from detection of two-dimensional data by photodetector 325 to reproduce data sending processing 624 in input and output control circuit 90.

A flow of data processing upon reproduce will be described with reference to FIG. 6. Image data detected by photodetector 325 is transferred to signal processing circuit 85 (911). An image position is detected based a marker included in the image data (912). Deformation such as inclination, magnification, and distortion of the image is then compensated (913) and binarization processing is performed (914). Removing the marker (915) then acquiring two-dimensional data for one page (916). The two-dimensional data acquired in such a manner is converted into a plurality of data streams and then subjected to error correction processing (917) where a parity data stream is removed. Next, descramble processing is performed (918) and an error detection processing by CRC is performed (919) where CRC parity is erased. Thereafter, user data is sent via input and output control circuit 90 (920).

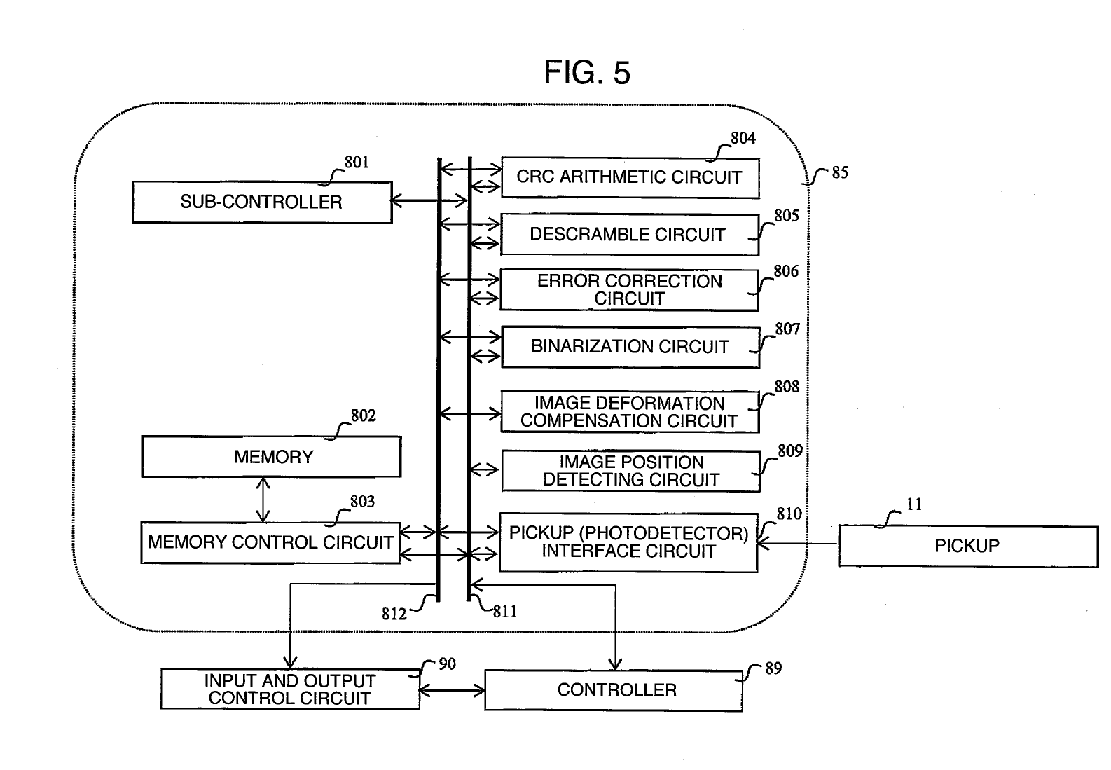

FIG. 5 is a block diagram illustrating signal processing circuit 85 in optical information reproduce device 10.

When photodetector 325 in pickup 11 detects image data, controller 89 commands signal processing circuit 85 to perform reproduce processing of the data for one page input from pickup 11. Sub-controller 801 in signal processing circuit 85 is notified of the processing command from controller 89 via control line 811. Upon reception of the notification, sub-controller 801 controls respective signal processing circuits via control line 811 such that the respective signal processing circuits operate in parallel. First, memory control circuit 803 is controlled such that the image data input from pickup 11 via pickup interface circuit 810 is stored in memory 802 via data line 812. When data stored in memory 802 reaches a certain quantity, image position detecting circuit 809 is controlled to detect the marker in the image data stored in memory 802 and to extract a range of valid data. Next, an image deformation compensation circuit 808 is controlled to perform compensation of deformation such as inclination, magnification, and distortion of the image and to convert the image data into two-dimensional data of a desired size. Binarization circuit 807 is controlled to binarize each bit data, each having a plurality of bits, included in the size-converted two-dimensional data through determination of “0” or “1” and to store the data in memory 802 in an order of outputting reproduce data. Next, error correction circuit 806 corrects errors included in each of the data streams and descramble circuit 805 descrambles scrambling of adding a pseudo-random number data stream. Thereafter, CRC arithmetic circuit 804 confirms that no error is included in the user data in memory 802. Thereafter, memory 802 transfers the user data to input and output control circuit 90.

Here, details of reproduce reference light optical system 12 and an adjustment method of movable mirror 324 will be described in detail by the inventors.

As described above, reproduce reference light optical system 12 is an optical system combining lens 327 and movable mirror 324.

Also, it is desirable that the reproduce reference light generated by reproduce reference light optical system 12 has the same angle, position, and aberration as those of the incident reference light.

Therefore, a relative position of lens 327 and movable mirror 324 is important.

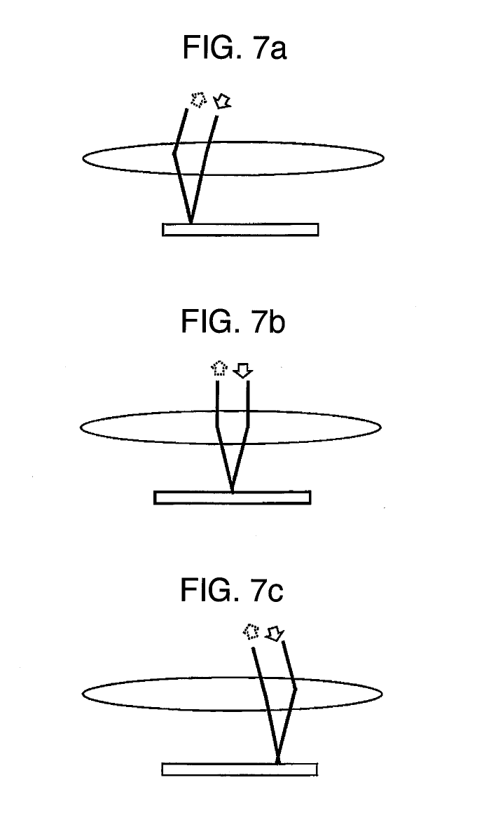

With reference to FIGS. 7 to 10, an influence of deviation from a desired state of movable mirror 324 on the reference light, entering reproduce reference light optical system 12, and the reproduce reference light emitted therefrom will be described.

FIGS. 7a to 7c are diagrams illustrating optical paths of the reproduce reference light when movable mirror 324 is positioned at a desirable position. FIGS. 7a to 7c each illustrates an optical path with a different incident angle of the reference light. Also, a solid line shows the reference light while a dotted line shows the reproduce reference light reflected by the mirror.

In FIG. 7a, lens 327 changes an optical axis of the incident reference light. Furthermore, the reference light is converted from parallel light to converging light and enters movable mirror 324. A reflection surface of movable mirror 324 is perpendicular to the optical axis of the incident light and positioned at a focal point of the converging light. The reflected light is diverging light and enters to lens 327 while passing the same optical path as that of the incident light. The light having passed through the lens is parallel light which proceeds the same optical path as that of the incident light in the opposite direction.

In FIGS. 7b and 7c, the distance and angle between movable mirror 324 and lens are optimum as in FIG. 7a. The reproduce reference light is emitted along entirely the same optical path as that of the incident reference light.

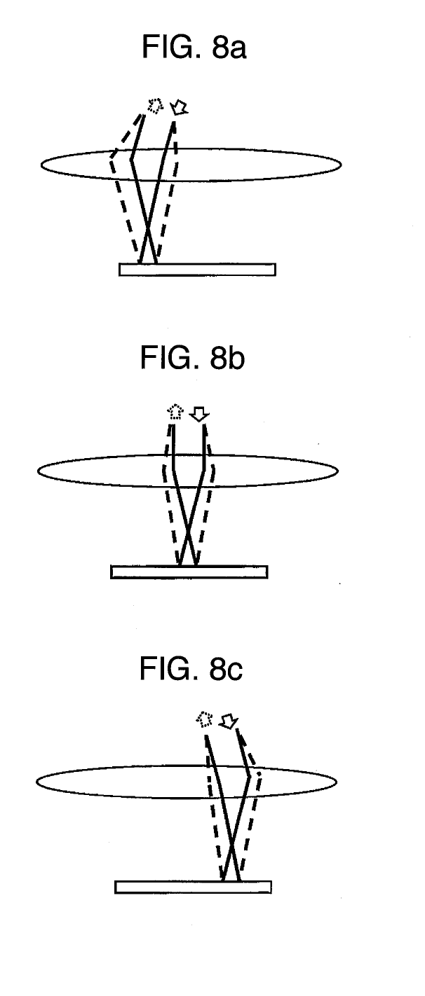

FIGS. 8a to 8c are diagrams illustrating optical paths of the reproduce reference light when movable mirror 324 is far from lens 327. FIGS. 8a to 8c each illustrates an optical path with a different incident angle of the reference light. Also, a solid line shows the reference light while a dotted line shows the reproduce reference light reflected by the mirror.

In FIG. 8a, lens 327 changes an optical axis of the incident reference light. Furthermore, the reference light is converted from parallel light to converging light and enters movable mirror 324. The reflection surface of movable mirror 324 is perpendicular to the optical axis of the incident light but positioned farther than the focal point of the converging light. Therefore, the converging light becomes diverging light and then enters the mirror. The reflected light is expanded from the incident light and enters lens 327. The light having passed the lens is converging light and is emitted from reproduce reference light optical system 12.

In FIGS. 7b and 7c, the distance between movable mirror 324 and lens is far as in FIG. 7a. Therefore, the reproduce reference light is emitted as converging light.

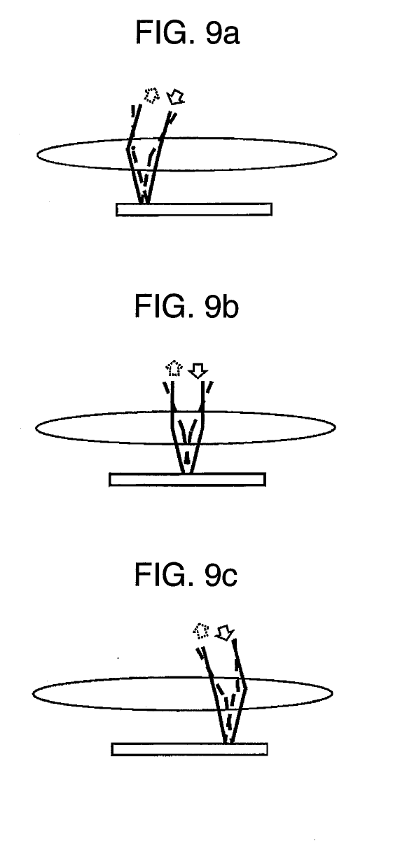

FIGS. 9a to 9c are diagrams illustrating optical paths of the reproduce reference light when movable mirror 324 is close to lens 327. FIGS. 9a to 9c each illustrates an optical path with a different incident angle of the reference light. Also, a solid line shows the reference light while a dotted line shows the reproduce reference light reflected by the mirror.

In FIG. 9a, lens 327 changes an optical axis of the incident reference light. Furthermore, the reference light is converted from parallel light to converging light and enters to movable mirror 324. The reflection surface of movable mirror 324 is perpendicular to the optical axis of the incident light but positioned closer than the focal point of the converging light. Therefore, the converging light continues to converge even after reflection by the mirror and then becomes diverging light. The reflected light shrinks from the incident light and enters to lens 327. The light having passed the lens is diverging light and is emitted from reproduce reference light optical system 12.

In FIGS. 9b and 9c, the distance between movable mirror 324 and lens is close as in FIG. 9a. Therefore, the reproduce reference light is emitted as diverging light.

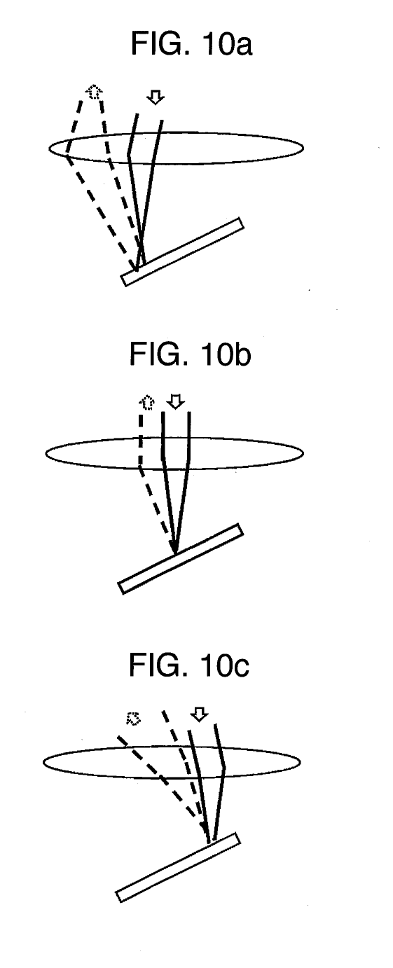

FIGS. 10a to 10c are diagrams illustrating optical paths of the reproduce reference light when movable mirror 324 is inclined to lens 327. FIGS. 10a to 10c each illustrates an optical path with a different incident angle of the reference light. Also, a solid line shows the reference light while a dotted line shows the reproduce reference light reflected by the mirror.

In FIG. 10a, lens 327 changes an optical axis of the incident reference light. Furthermore, the reference light is converted from parallel light to converging light and enters to movable mirror 324. The reflection surface of movable mirror 324 is not perpendicular to the optical axis of the incident light and positioned farther than the focal point of the converging light. Therefore, the converging light is in focus before reflection by the mirror and becomes diverging light. The optical axis of the reflected light varies according to inclination of movable mirror 324 and a spot size of the light entering to lens 327 is expanded as in FIG. 8a. The reproduce reference light having passed through lens 327 has a different angle from that of the incident reference light and is converging light.

In FIG. 10b, lens 327 changes the optical axis of the incident reference light. Furthermore, the reference light is converted from parallel light to converging light and enters movable mirror 324. The reflection surface of movable mirror 324 is not perpendicular to the optical axis of the incident light but positioned at the focal point of the converging light. Therefore, the converging light is in focus at the reflected position by the mirror. The reflected light is diverging light. Also, the optical axis of the reflected light varies according to inclination of movable mirror 324 and enters lens 327. The reproduce reference light having passed lens 327 has a different angle from that of the incident reference light but is parallel light.

In FIG. 10c, lens 327 changes the optical axis of the incident reference light. Furthermore, the reference light is converted from parallel light to converging light and enters movable mirror 324. The reflection surface of movable mirror 324 is not perpendicular to the optical axis of the incident light and positioned closer than the focal point of the converging light. Therefore, the converging light is in focus after reflection by the mirror and becomes diverging light. Also, the optical axis of the reflected light varies according to inclination of movable mirror 324 and a spot size of the light entering lens 327 is expanded as in FIG. 9a. The reproduce reference light having passed through lens 327 has a different angle from that of the incident reference light and is diverging light.

As described above, the reproduce reference light generated varies according to a position and inclination of movable mirror 324.

Reproduce of a hologram has an attribute that a reproduce signal can be obtained only by reference light same as or phase conjugate to that of recording.

Therefore, reproduce reference light where movable mirror 324 is deviated from a desired state results in deterioration of reproduce performance.

Therefore, optical information reproduce device 10 is required to be adjusted such that movable mirror 324 is moved to the optimum position.

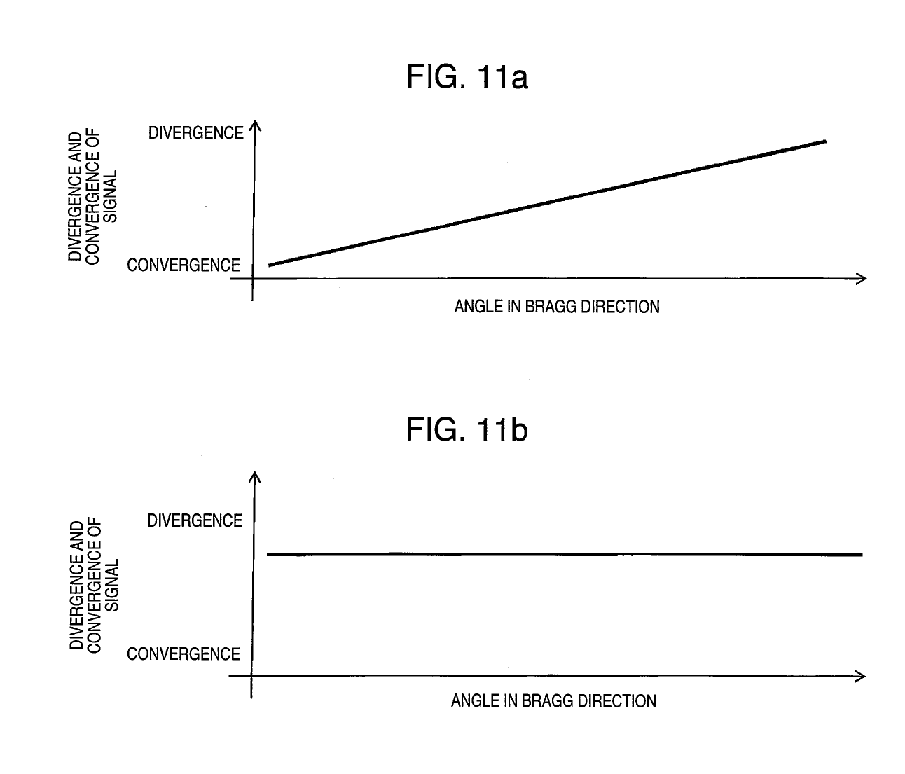

Next, a method for adjusting an angle of movable mirror 324 will be described with reference to FIGS. 11a and 11b.

FIGS. 11a and 11b are tables illustrating outputs from reference light adjustment signal detecting circuit 92 upon scanning with the reference light in the Bragg direction. In FIG. 11a, the reproduce reference light varies from convergence to divergence corresponding to scanning with the reference light in the Bragg direction. This shows that movable mirror 324 is inclined. Also, a direction of the variation between divergence and convergence shows a direction of inclination. When moving actuator 323, such that the inclination of the movable mirror is compensated, results in a magnitude of divergence or convergence of the reproduce reference light not to vary as in FIG. 11b, even upon scanning with the reference light, this means that the inclination of movable mirror 324 is compensated.

Here, the Bragg direction is a direction of incident angle of the reference light in a direction of multiplexing upon angle-multiplexing on optical information recording medium 1. The pitch direction is an angle perpendicular to the Bragg direction. The pitch direction will be described later.

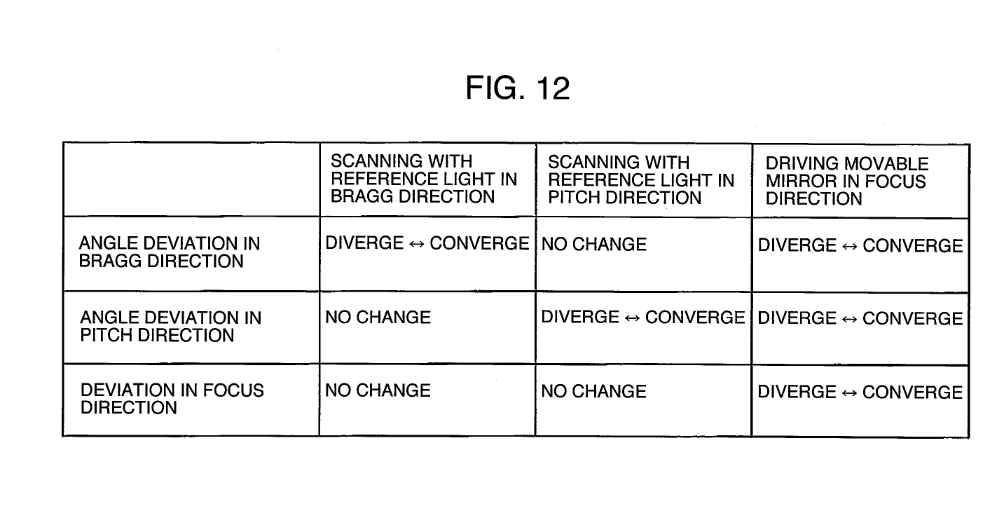

FIG. 12 is a table illustrating variation in the reproduce reference light by scanning with the reference light according to deviation direction of movable mirror 324.

As described above, the reproduce reference light does not vary when there is no angle deviation in the movable mirror relative to a scanning direction with the reference light. Based on this, by measuring variation in the reproduce reference light by scanning with the reference light in the direction of an angle, it becomes possible to adjust movable mirror 324 at the optimum angle.

An amount of deviation in the direction of focal point is only required to be adjusted such that an output from the reproduce reference light becomes parallel as stored, for example, in a memory included in controller 89.

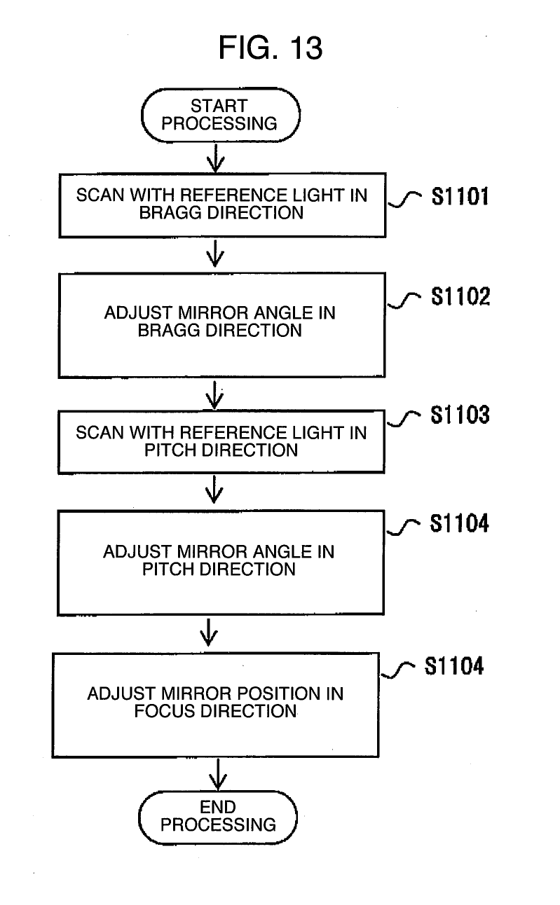

FIG. 13 is a diagram illustrating a flow of adjusting positioning of movable mirror 324.

When the adjusting processing starts, scanning with the reference light is performed in the Bragg direction. (S1101)

An amount of deviation from the optimum angle of movable mirror 324 is measured as described above from the output from reference light adjustment signal detecting circuit 92 during scanning and an angle of movable mirror 324 in the Bragg direction is adjusted. (S1102)

Thereafter, scanning with the reference light is performed in the pitch direction (S1103), thereby adjusting the angle of movable mirror 324 in the pitch direction as have performed in the Bragg direction. (S1104)

Lastly, the mirror position is adjusted in the direction of focal point based on a value from the reproduce reference light adjustment signal detecting circuit (S1105). The adjustment of position here is performed such that an output from the reproduce reference light becomes parallel as stored, for example, in a memory included in controller 89.

By performing the adjustment in the above manner, light output from reproduce reference light optical system 12 becomes parallel light and the reproduce reference light can be emitted at an angle confronting the incident angle. This realizes reproduce of a hologram with good reproduce performance.

Adjusting movable mirror 324 based on reference light adjustment signal detecting circuit 92 as described above realizes adjustment of the angle and divergence or convergence of the reproduce reference light at a desired value. By performing the above method, an accuracy of attaching movable mirror 324 upon manufacturing optical information reproduce device 10 may be rough.

Also, deviation in position of movable mirror 324 due to thermal expansion caused by a temperature change or aged deterioration may be compensated through adjustment.

Performing this compensation before reproduce of data realizes adjustment of movable mirror 324 at the optimum position during reproduce.

Furthermore, measuring an output from reference light adjustment signal detecting circuit 92 during data reproduce and performing the compensation processing when an amount of variation is equal to or larger than a preset value realizes acquisition of a reproduce signal with the optimum reproduce reference light at all times.

Note that the present invention is not limited to the aforementioned embodiments but includes various variations. For example, the aforementioned embodiments are described in detail for easier understanding of the description of the present invention and are not necessarily limited to those including the entire configuration having been described. Also, a part of the configuration of one of the embodiments can be replaced by the configuration of the other embodiment and the configuration of the other embodiment can also be added to the configuration of one of the embodiments. Furthermore, another configuration can be added to, removed from, or replace with a part of the configuration of the respective embodiments.

Also, a part or all of the aforementioned respective configurations, functions, processors, processing units, or the like may be implemented by hardware such as designing an integrated circuit. Also, the aforementioned respective configurations, functions, or the like may be implemented by software such as by interpretation and execution of a program, implementing the respective functions, by a processor. Information such as a program, table, and file implementing the respective functions may be stored in a recording device such as a memory, hard disk, and solid state drive (SSD) or a recording medium such as an IC card, SD card, and a DVD.

Illustrated here are the control line and data line considered necessary for description. And thus not all the control lines or the data lines in a product may be illustrated. In practice, almost all the configurations are considered to be connected to each other.

### REFERENCE SIGNS LIST

1 Optical information recording medium
10 Optical information recording and reproduce device
11 Pickup
12 Reproduce reference light optical system
14 Disk rotation angle detecting optical system
81 Access control circuit
82 Light source driving circuit
83 Servo signal generation circuit
84 Servo control circuit
85 Signal processing circuit
86 Signal generation circuit
88 Disk rotation motor control circuit
89 Controller
90 Input and output control circuit
91 External control device
301 Reference light adjustment signal detecting circuit
301 Light source
331 PBS prism
320 Actuator
321 Lens
322 Lens
323 Actuator
327 Lens
324 Mirror
325 Photodetector

1. An optical information reproduce device configured to reproduce information recorded on an optical information recording medium by an angle-multiplexed holography, the device comprising:
a light source configured to generate reference light;
a first actuator configured to vary an incident angle of the reference light generated by the light source into the optical information recording medium;
a phase conjugate generating unit configured to generate phase conjugate light of light transmitted by the optical information recording medium, the unit comprising a condenser lens and a movable mirror;
a second actuator configured to drive the movable mirror; and
a reference light measuring unit configured to measure divergence or convergence of the phase conjugate light.

2. The optical information reproduce device according to claim 1, wherein the second actuator is configured to drive the operation mirror according to a measuring result from the reference light measuring unit.

3. The optical information reproduce device according to claim 1, wherein the second actuator is configured to drive the movable mirror such that the measuring result from the reference light measuring unit when the first actuator is driven is equal to or less than a predetermined value.

4. The optical information reproduce device according to claim 2, wherein driving the second actuator is performed before reproduce of the information in the optical information recording medium.

5. The optical information reproduce device according to claim 3, wherein driving the second actuator is performed before reproduce of the information in the optical information recording medium.

6. The optical information reproduce device according to claim 2,
wherein variation in signals from the reference light measuring unit is measured during reproduce of the information from the optical information recording medium, and
driving the second actuator is performed when an amount of variation in the signals is larger than a predetermined value.

7. The optical information reproduce device according to claim item 3,
wherein variation in signals from the reference light measuring unit is measured during reproduce of the information from the optical information recording medium, and
driving the second actuator is performed when an amount of variation in the signals is larger than a predetermined value.

8. The optical information reproduce device according to claim 1, wherein the reference light measuring unit is configured to measure the phase conjugate light generated by the phase conjugate generating unit in downstream of the first actuator.

9. A movable mirror adjustment method for adjusting a position of the movable mirror in the optical information reproduce device configured to reproduce the information recorded on the optical information recording medium by the angle-multiplexed holography according to claim 1, the method comprising the steps of:
measuring divergence or convergence of the phase conjugate light; and
driving the movable mirror according to the measuring result.

10. The movable mirror adjustment method according to claim 9, the method comprising the step of driving the first actuator, wherein, in the step of driving the movable mirror, the movable mirror is driven such that the step of driving the first actuator allows the measuring result from the step of measuring divergence or convergence of the phase conjugate light to be equal to or less than a predetermined value.

11. The movable mirror adjustment method according to claim 9, wherein the adjustment method is performed before reproduce of the information in the optical information recording medium.

12. The movable mirror adjustment method according to claim 10, wherein the adjustment method is performed before reproduce of the information in the optical information recording medium.

13. The movable mirror adjustment method according to claim 9, the adjustment method comprising the step of measuring variation in signals from the reference light measuring unit during reproduce of the information from the optical information recording medium,
wherein adjusting the mirror is performed when an amount of variation in the signals is larger than a predetermined value.

14. The movable mirror adjustment method according to claim 10, the adjustment method comprising the step of measuring variation in signals from the reference light measuring unit during reproduce of the information from the optical information recording medium,
wherein adjusting the mirror is performed when an amount of variation in the signals is larger than a predetermined value.
